(19) United States
(12) Patent Application Publication
(10) Pub. No.: US 2012/0269350 A1
(43) Pub. Date: Oct. 25, 2012

(54) AUDIO DATA PROCESSING APPARATUS, AUDIO APPARATUS, AND AUDIO DATA PROCESSING METHOD

(75) Inventors: Junsei Sato, Osaka-shi (JP); Hisao Hattori, Osaka-shi (JP); Chanbin Ni, Osaka-shi (JP)

(73) Assignee: SHARP KABUSHIKI KAISHA, Osaka-shi, Osaka (JP)

(21) Appl. No.: 13/514,902

(22) PCT Filed: Dec. 1, 2010
(86) PCT No.: PCT/JP2010/071491

§ 371 Date: Jul. 6, 2012

(30) Foreign Application Priority Data
Dec. 9, 2009 (JP) 2009-279794

(51) Int. Cl. H04R 5/00

(52) U.S. Cl. 381/17

(57) ABSTRACT

An audio data processing apparatus and the like are provided in which waveform distortion generated when a virtual sound source moves is resolved so that noise caused by waveform distortion is reduced remarkably. The present invention includes: a step of calculating distances measured at different time points between the position of the virtual sound source and a speaker; a step of, when these distances are different from each other, judging whether the virtual sound source is departing or approaching relative to the speaker; and a step of identifying and correcting the part of waveform distortion depending on departing or approaching.

This application is the national phase under 35 U.S.C. §371 of PCT International Application No. PCT/JP2010/071491 filed on Dec. 1, 2010, which claims priority under 35 U.S.C. 119(a) to Patent Application No. 2009-279794 filed in Japan on Dec. 9, 2009, all of which are hereby expressly incorporated by reference into the present application.

### BACKGROUND

1. Technical Field

The present invention relates to an audio data processing apparatus, an audio apparatus, an audio data processing method, a program, and a recording medium recording this program.

2. Description of Related Art

In recent years, researches for audio systems employing basic principles of wave field synthesis (WFS) are actively carried out in Europe and other regions (for example, see Non-patent Document 1 (A. J. Berkhout, D. de Vries, and P. Vogel (The Netherlands), Acoustic control by wave field synthesis, The Journal of the Acoustical Society of America (J. Acoust. Soc.), Volume 93, Issue 5, May 1993, pp. 2764-2778)). The WFS is a technique that the wave front of sound emitted from a plurality of speakers (referred to as a “speaker array”, hereinafter) arranged in the shape of an array is synthesized on the basis of Huygens' principle.

A listener who listens sound in front of a speaker array in sound space provided by a WFS receives feeling as if sound emitted actually from the speaker array were emitted from a sound source (referred to as a “virtual sound source”, hereinafter) virtually present behind the speaker array (for example, see FIG. 1).

Apparatuses to which WFS systems are applicable include movies, audio systems, televisions, AV racks, video conference systems, and TV games. For example, in a case that digital contents are a movie, the presence of each actor is recorded on a medium in the shape of a virtual sound source. Thus, when an actor who is speaking moves inside the screen space, the virtual sound source is allowed to be located left, right, back, and forth, and in an arbitrary direction within the screen space in accordance with the direction of movement of the actor inside the screen space. For example, Patent Document 1 (Japanese Unexamined Patent Application Publication No. 2007-502590) describes a system achieving the movement of a virtual sound source.

### SUMMARY

In a physical phenomenon known as the Doppler effect, the frequency of sound waves are observed in different values depending on the relative velocity between a sound source which is a source generating sound waves and a listener. According to the Doppler effect, when a sound source which is a source generating sound waves approaches a listener, the oscillation of sound waves is compressed and hence the frequency becomes higher. On the contrary, when the sound source departs from the listener, the oscillation of sound waves is expanded and hence the frequency becomes lower. This indicates that even when the sound source moves, the number of waves of the sound reaching from the sound source does not change.

Nevertheless, in the technique described in Non-patent Document 1, it is premised that the virtual sound source is fixed and not moving. Thus, the Doppler effect occurring in association with the movement of the virtual sound source is not taken into consideration. Thus, when the virtual sound source moves in a direction of departing from the speaker or in a direction of approaching, the number of waves of the audio signal providing the basis of the sound generated by the speaker is changed and hence the change in the number of waves causes distortion in the waveform. When distortion is caused in the waveform, the listener perceives the distortion as noise. Thus, means resolving the waveform distortion need be provided. Details of distortion in the waveform are described later.

On the other hand, in the method described in Patent Document 1, with taking into consideration the Doppler effect generated in association with the movement of the virtual sound source, a weight coefficient is changed for the audio data in a range from suitable sample data within a particular segment in the audio data providing the basis of the audio signal to suitable sample data in the next segment, so that the audio data in the range is corrected. Here, the “segment” indicates the unit of processing of audio data. When the audio data is corrected, extreme distortion in the audio signal waveform is resolved to some extent and hence noise caused by the waveform distortion is reduced.

Nevertheless, in the method described in Patent Document 1, merely the smoothing of audio data is simply performed. That is, the method described in Patent Document 1 is different from that waveform distortion is identified in accordance with approaching or departing of the virtual sound source relative to the speaker and then different correction is performed in accordance with the identified waveform distortion. As a result, in the method described in Patent Document 1, waveform distortion is remained frequently and hence a problem arises that satisfactory effect of avoiding noise caused by waveform distortion is not achieved.

The present invention has been devised in view of this problem. An object of the present invention is provide an audio data processing apparatus and the like in which the part of waveform distortion is identified depending on the approaching or departing of the virtual sound source relative to the speaker and then different correction is performed in accordance with the waveform distortion so that waveform distortion generated when the virtual sound source moves is resolved and hence noise caused by the waveform distortion is avoided.

The audio data processing apparatus according to the present invention is an audio data processing apparatus that receives audio data corresponding to sound generated by a moving virtual sound source, a position of the virtual sound source, and a position of a speaker emitting sound on the basis of the audio data and that corrects the audio data on the basis of the position of the virtual sound source and the position of the speaker, the apparatus comprising: calculating means calculating first and second distances measured at two time points from the position of the speaker to the position of the virtual sound source; comparing means comparing the first and the second distances with each other; identifying means, when the first and the second distances are different from each other as a result of comparison, identifying a distorted part in the audio data at the two time points; and correcting means performing different correction on the audio data of the identified part depending on approaching or departing of the virtual sound source relative to the speaker.

In the audio data processing apparatus according to the present invention, the audio data contains sample data, the identifying means identifies a repeated part of the sample data caused by departing of the virtual sound source from the speaker, and the correcting means includes first correcting means correcting the identified repeated part.

In the audio data processing apparatus according to the present invention, the audio data contains sample data, the identifying means identifies a lost part of the sample data caused by approaching of the virtual sound source to the speaker, and the correcting means includes second correcting means correcting the preceding and the following parts of the identified lost part.

In the audio data processing apparatus according to the present invention, the audio data contains sample data, the identifying means identifies a repeated part of the sample data or a lost part of the sample data caused by approaching and departing of the virtual sound source relative to the speaker, and the correcting means includes: first correcting means correcting the identified repeated part; and second correcting means correcting the preceding and the following parts of the identified lost part.

In the audio data processing apparatus according to the present invention, the part to be processed by the correction has a time width equal to a difference between time widths during propagation of the sound waves through the first and the second distances or a time width proportional to the difference.

In the audio data processing apparatus according to the present invention, the first correcting means replaces the sample data contained in the identified repeated part with sample data obtained by uniformly expanding, into twice the time width, one of two waveforms formed on the basis of the sample data.

In the audio data processing apparatus according to the present invention, the second correcting means replaces the sample data contained in the identified lost part and in the preceding and the following parts of the lost part with sample data obtained by uniformly compressing into ⅔ of the time width a waveform formed on the basis of the sample data.

The audio data processing apparatus according to the present invention further comprises means performing gain control on the audio data corrected by the correcting means.

In the audio data processing apparatus according to the present invention, the number of the virtual sound sources is unity or a plurality.

The audio apparatus according to the present invention is an audio apparatus that uses audio data corresponding to sound generated by a moving virtual sound source, a position of the virtual sound source, and a position of a speaker emitting sound on the basis of the audio data and that thereby corrects the audio data on the basis of the position of the virtual sound source and the position of the speaker, the apparatus comprising: a digital contents input part receiving digital contents containing the audio data and the position of the virtual sound source; a contents information separating part analyzing the digital contents received by the digital contents input part and separating audio data and position data of the virtual sound source contained in the digital contents; an audio data processing part, on the basis of the position data of the virtual sound source separated by the contents information separating part and the position data of the speaker, correcting the audio data separated by the contents information separating part; and an audio signal generating part, on the basis of the corrected audio data, generating an audio signal to the speaker, wherein the audio data processing part includes: means calculating first and second distances measured at two time points from the position of the speaker to the position of the virtual sound source; means comparing the first and the second distances with each other; means, when the first and the second distances are different from each other as a result of comparison, identifying a distorted part in the audio data at the two time points; and means performing different correction on the audio data of the identified part depending on approaching or departing of the virtual sound source relative to the speaker.

In the audio apparatus according to the present invention, the digital contents input part receives digital contents from a recording medium storing digital contents, a server distributing digital contents through a network, or a broadcasting station broadcasting digital contents.

The audio data processing method according to the present invention is an audio data processing method employed in an audio data processing apparatus that receives audio data corresponding to sound generated by a moving virtual sound source, a position of the virtual sound source, and a position of a speaker emitting sound on the basis of the audio data and that corrects the audio data on the basis of the position of the virtual sound source and the position of the speaker, the method comprising: a step of calculating first and second distances measured at two time points from the position of the speaker to the position of the virtual sound source; a step of comparing the first and the second distances with each other; a step of, when the first and the second distances are different from each other as a result of comparison, identifying a distorted part in the audio data at the two time points; and a step of performing different correction on the audio data of the identified part depending on approaching or departing of the virtual sound source relative to the speaker.

The program according to the present invention is a program that receives audio data corresponding to sound generated by a moving virtual sound source, a position of the virtual sound source, and a position of a speaker emitting sound on the basis of the audio data and that corrects the audio data on the basis of the position of the virtual sound source and the position of the speaker, the program causing a computer to execute: a step of calculating first and second distances measured at two time points from the position of the speaker to the position of the virtual sound source; a step of comparing the first and the second distances with each other; a step of, when the first and the second distances are different from each other as a result of comparison, identifying a distorted part in the audio data at the two time points; and a step of performing different correction on the audio data of the identified part depending on approaching or departing of the virtual sound source relative to the speaker.

The recording medium according to the present invention records the above-mentioned program.

In the audio data processing apparatus according to the present invention, when the first and the second distances are different from each other, a distorted part is identified in the audio data at two time points. Then, different correction on the audio data of the identified part is performed depending on approaching or departing of the virtual sound source relative to the speaker. Thus, waveform distortion caused by the movement of the virtual sound source is resolved.

In the audio data processing apparatus according to the present invention, correction is performed on the repeated part of the sample data caused by departing of the virtual sound source relative to the speaker. Thus, waveform distortion generated when the virtual sound source is departing from the speaker is resolved.

In the audio data processing apparatus according to the present invention, correction is performed on the lost part of the sample data caused by approaching of the virtual sound source relative to the speaker. Thus, waveform distortion generated when the virtual sound source is approaching the speaker is resolved.

In the audio data processing apparatus according to the present invention, the repeated part of the sample data and the lost part of the sample data caused by approaching and departing of the virtual sound source relative to the speaker are corrected. Thus, waveform distortion generated when the virtual sound source is approaching and departing relative to the speaker is resolved.

In the audio data processing apparatus according to the present invention, correction by gain control is further performed on the sample data having undergone the above-mentioned correction. Thus, waveform distortion caused by approaching and departing of the virtual sound source relative to the speaker is corrected.

In the audio apparatus according to the present invention, when the first and the second distances are different from each other, a distorted part is identified in the audio data at two time points. Then, different correction on the audio data of the identified part is performed depending on approaching or departing of the virtual sound source relative to the speaker. Thus, an audio signal is outputted in which waveform distortion caused by the movement of the virtual sound source is resolved.

In the audio data processing method according to the present invention, when the first and the second distances are different from each other, a distorted part is identified in the audio data at two time points. Then, different correction on the audio data of the identified part is performed depending on approaching or departing of the virtual sound source relative to the speaker. Thus, waveform distortion caused by the movement of the virtual sound source is resolved.

In the program according to the present invention, when the first and the second distances are different from each other, a distorted part is identified in the audio data at two time points. Then, different correction on the audio data of the identified part is performed depending on approaching or departing of the virtual sound source relative to the speaker. Thus, waveform distortion caused by the movement of the virtual sound source is resolved.

In the computer-readable recording medium according to the present invention, when the first and the second distances are different from each other, a distorted part is identified in the audio data at two time points. Then, different correction on the audio data of the identified part is performed depending on approaching or departing of the virtual sound source relative to the speaker. Thus, waveform distortion generated when the virtual sound source moves is resolved.

According to the audio data processing apparatus and the like according to the present invention, audio data is corrected when the virtual sound source moves. Thus, waveform distortion caused by the movement of the virtual sound source is resolved and hence noise caused by the waveform distortion can be avoided.

The above and further objects and features will more fully be apparent from the following detailed description with accompanying drawings.

### BRIEF DESCRIPTION OF THE SEVERAL VIEWS OF THE DRAWINGS

FIG. 1 is an explanation diagram for an example of sound space provided by a WFS.

FIG. 2A is an explanation diagram generally describing an audio signal.

FIG. 2B is an explanation diagram generally describing an audio signal.

FIG. 2C is an explanation diagram generally describing an audio signal.

FIG. 3 is an explanation diagram for a part of an audio signal waveform formed on the basis of audio data.

FIG. 4 is an explanation diagram for an example of an audio signal waveform formed on the basis of audio data within a first segment.

FIG. 5 is an explanation diagram for an example of an audio signal waveform formed on the basis of audio data within a second segment.

FIG. 6 is an explanation diagram for an example of an audio signal waveform obtained by combining the audio signal waveform formed on the basis of the audio data illustrated in FIG. 4 and the audio signal waveform formed on the basis of the audio data illustrated in FIG. 5.

FIG. 7 is an explanation diagram for an example of an audio signal waveform formed on the basis of audio data within a first segment.

FIG. 8 is an explanation diagram for an example of an audio signal waveform formed on the basis of audio data within a second segment.

FIG. 9 is an explanation diagram illustrating a situation that a lost part of four points occurs between an audio signal waveform formed on the basis of audio data of the beginning part of a first segment and an audio signal waveform formed on the basis of audio data of the final part of a second segment.

FIG. 10 is an explanation diagram for an example of an audio signal waveform obtained by combining the audio signal waveform formed on the basis of the audio data illustrated in FIG. 7 and the audio signal waveform formed on the basis of the audio data illustrated in FIG. 8.

FIG. 11 is a block diagram illustrating an exemplary configuration of an audio apparatus employing an audio data processing part according to Embodiment 1.

FIG. 12 is a block diagram illustrating an exemplary internal configuration of the audio data processing part according to Embodiment 1.

FIG. 13 is an explanation diagram for an exemplary configuration of an input audio data buffer.

FIG. 14 is an explanation diagram for an exemplary configuration of a sound wave propagation time data buffer.

FIG. 15 is an explanation diagram for an audio signal waveform formed on the basis of corrected audio data.

FIG. 16 is an explanation diagram for an audio signal waveform formed on the basis of corrected audio data.

FIG. 17 is a flow chart describing flow of data processing according to Embodiment 1.

FIG. 18 is a flow chart describing flow of identifying and correcting a distorted part of a waveform.

FIG. 19 is a block diagram illustrating an exemplary internal configuration of an audio apparatus according to Embodiment 2.

### DETAILED DESCRIPTION

### Embodiment 1

First, description is given for: a calculation model assuming that the virtual sound source does not move in sound space provided by a WFS; and a calculation model taking into consideration the movement of the virtual sound source. Then, an embodiment is described.

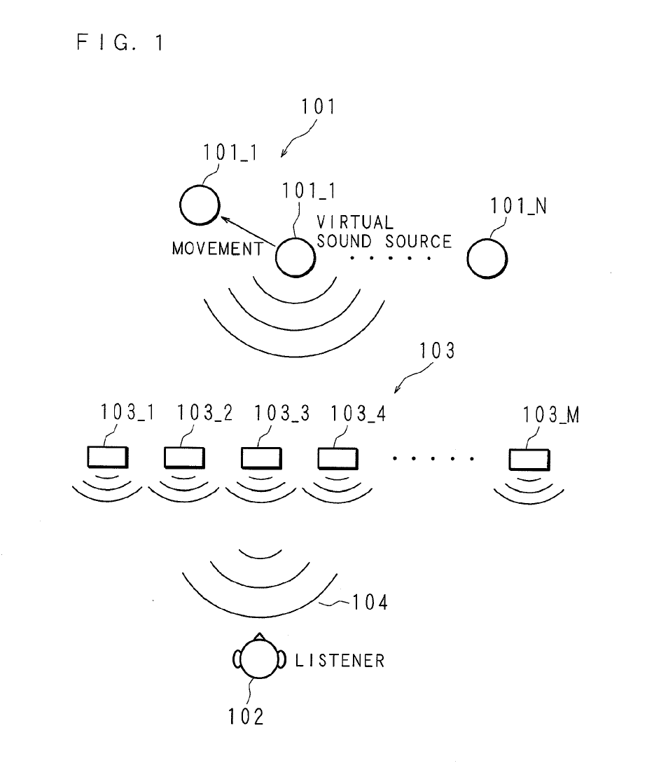

FIG. 1 is an explanation diagram for an example of sound space provided by a WFS. The sound space illustrated in FIG. 1 contains: a speaker array 103 constructed from M speakers 103_1 to 103_M; and a listener 102 who listens sound in front of the speaker array 103. In this sound space, the wave fronts of sound emitted from the M speakers 103_1 to 103_M undergo wave field synthesis based on Huygens' principle, and then propagate through the sound space in the form of a composite wave front 104. At that time, the listener 102 receives feeling as if the sounds emitted actually from the speaker array 103 were emitted from actually-non-existing N virtual sound sources 101_1 to 101_N located behind the speaker array 103. The virtual sound sources 101_1 to 101_N are collectively referred to as a virtual sound source 101.

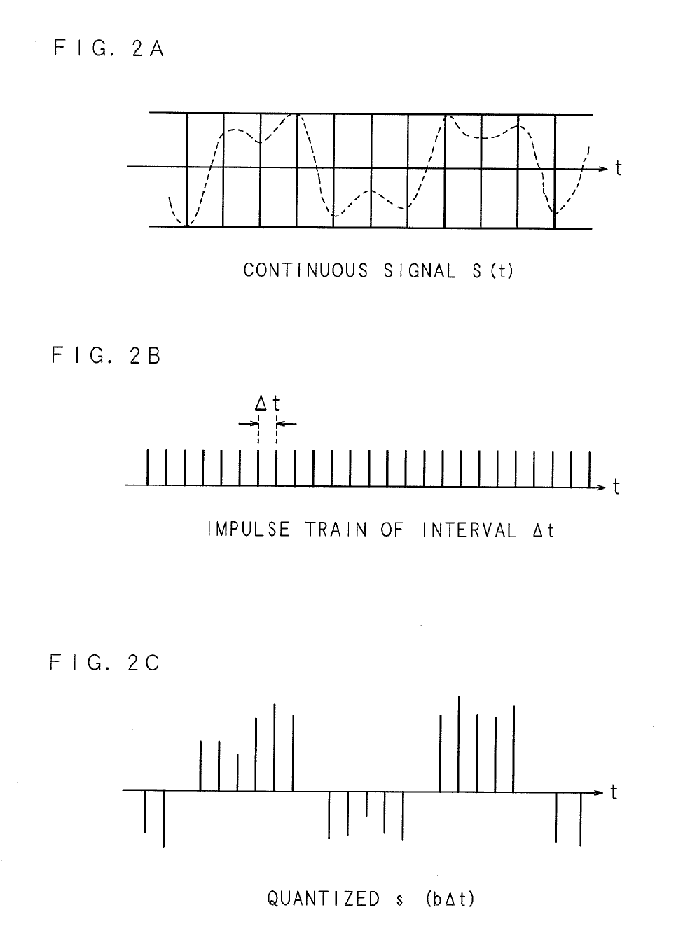

On the other hand, FIGS. 2A, 2B, and 2C are explanation diagrams generally describing audio signals. When an audio signal is to be treated theoretically, in general, the audio signal is expressed as a continuous signal S(t). FIG. 2A illustrates a continuous signal S(t). FIG. 2B illustrates an impulse train with sampling period Δt. FIG. 2C illustrate data s(bΔt) obtained by sampling and quantizing the continuous signal S(t) with sampling period Δt (here, b is a positive integer). For example, as illustrated in FIG. 2A, the continuous signal S(t) is continuous along the axis of time t and similarly along the axis of amplitude S. The sampling is performed in order to acquire a time-discrete signal from the continuous signal S(t). As a result, the continuous signal S(t) is expressed by data s(bΔt) at discrete time bΔt. Theoretically, the sampling intervals may be variable. However, fixed intervals are more practical. The operation of sampling and quantization is performed such that when the sampling period is denoted by Δt, as illustrated in FIG. 2C, the continuous signal S(t) is interlaced by the impulse train (FIG. 2B) of interval Δt so that quantization is achieved. Here, in the following description, the quantized data s(bΔt) is referred to as “sample data”.

In the present calculation model, sample data at time t is generated for an audio signal provided to the m-th speaker (referred to as the “speaker 103_{—}m”, hereinafter) contained in the speaker array 103. Here, as illustrated in FIG. 1, it is assumed that the number of virtual sound sources 101 is N and the number of speakers constituting the speaker array 103 is M.

$${l}_{m} ( t ) = {\sum }_{n = 1}^{N} {q}_{n} ( t ) \qquad ( 1 )$$

Here,

qₙ(t) is sample data at discrete time t of sound wave emitted from the n-th virtual sound source (referred to as the “virtual sound source 101_{—}n”, hereinafter) among the N virtual sound sources 101 and then having reached the speaker 103_{—}m among the M speakers, and

lₘ(t) is sample data at discrete time t of an audio signal provided to the speaker 103_{—}m.

qₙ=Gₙ·sₙ(t−τₘₙ) (2)

Here,

Gₙ is a gain coefficient for the virtual sound source 101_{—}n,

sₙ(t) is sample data at discrete time t of an audio signal provided to the virtual sound source 101_{—}n, and

τₘₙ is the number of samples corresponding to the sound wave propagation time corresponding to the distance between the position of the virtual sound source 101_{—}n and the position of the speaker 103_{—}m.

$${G}_{n} = \frac{w}{\sqrt{\vert {r}_{n} - {r}_{m} \vert}} \qquad ( 3 )$$

Here,

w is a weight constant,

rₙ is the position vector (fixed value) of the virtual sound source 101_{—}n, and

rₘ is the position vector (fixed value) of the speaker 103_{—}m.

$${τ}_{mn} = ⌊ R \frac{\vert {r}_{n} - {r}_{m} \vert}{c} ⌋ \qquad ( 4 )$$

is a floor symbol,

R is the sampling rate, and

c is the speed of sound in air.

Here, the floor symbol expresses “an integer that is maximum among those not exceeding a given value”. As seen from Equations (3) and (4), in the present calculation model, the gain coefficient Gₙ for the virtual sound source 101_{—}n is inverse proportional to the square root of the distance from the virtual sound source 101_{—}n to the speaker 103_{—}m. This is because the set of the speakers 103_{—}m is modeled as a line of sound source. On the other hand, τₘₙ is proportional to the distance from the virtual sound source 101_{—}n to the speaker 103_{—}m.

In Equations (1) to (4), it is premised that the virtual sound source 101_{—}n does not move and stands still at a particular position. Nevertheless, in the real world, persons speak while walking, and automobiles run while generating engine sound. That is, in the real world, a sound source stands still in some cases and moves in some cases. Thus, in order to treat these cases, a new calculation model (calculation model according to an embodiment) is introduced which takes into consideration a situation that a sound source moves. This new calculation model is described below.

When a situation that the virtual sound source 101_{—}n moves is taken into consideration, Equations (2) to (4) are replaced by Equations (5) to (7) given below.

qₙ(t)=G_{n,t}·sₙ(t−τ_{mn,t}) (5)

Here,

G_{n,t} is a gain coefficient for the virtual sound source 101_{—}n at discrete time t, and

τ_{mn,t} is the number of samples corresponding to the sound wave propagation time corresponding to the distance between the virtual sound source 101_{—}n and the speaker 103_{—}m at discrete time t.

$${G}_{n , t} = \frac{w}{\sqrt{\vert {r}_{n , t} - {r}_{m} \vert}} \qquad ( 6 )$$

Here,

r_{n,t} is the position vector of the virtual sound source 101_{—}n at discrete time t.

$${τ}_{mn , t} = ⌊ R \frac{\vert {r}_{n , t} - {r}_{m} \vert}{c} ⌋ \qquad ( 7 )$$

Since the virtual sound source 101_{—}n moves, as seen from Equations (5) to (7), the gain coefficient for the virtual sound source 101_{—}n, the position of the virtual sound source 101_{—}n, and the sound wave propagation time vary as a function of discrete time t.

In general, signal processing on the audio data is performed segment by segment. The “segment” is the unit of processing of audio data and is also referred to as a “frame”. For example, one segment is composed of 256 pieces of sample data or 512 pieces of sample data. Thus, lₘ(t) (sample data at discrete time t of an audio signal provided to the speaker 103_{—}m) in Equation (1) is calculated in the unit of segment. Thus, in the present calculation model, the segment of audio data calculated at discrete time t and used for generating the audio signal provided to the speaker 103_{—}m is expressed by a vector L_{m,t}. In this case, L_{m,t} is vector data constructed from “a” pieces of sample data (such as 256 pieces of sample data and 512 pieces of sample data) contained in one segment extending from discrete time t−a+1 to discrete time t. L_{m,t} is expressed by Equation (8).

L_{m,t}=(lₘ(t−a+1), lₘ(t−a+2), . . . , lₘ(t)) (8)

Thus, for example, L_{m,t0} at discrete time t₀ is expressed by

L_{m,t0}=(lₘ(t₀−a+1), lₘ(t₀−a+2), . . . , lₘ(t₀))

When this L_{m,t0} is obtained, L_{m,(t0+a)} is then calculated.

L_{m,(t0+a)} is expressed by

L_{m,(t0+a)}=(lₘ(t₀+1), lₘ(t₀+2), . . . , lₘ(t₀+a))

Since the audio data is processed segment by segment, it is practical that r_{n,t} also is calculated segment by segment. However, the frequentness of update of rₙ need not indispensably agree with the segment unit. Then, as a result of comparison between the virtual sound source position r_{n,t0} at discrete time t₀ and the virtual sound source position r_{n,t0-a} at discrete time (t₀−a), it is recognized that the virtual sound source position r_{n,t0} varies by the distance that the virtual sound source 101_{—}n has moved between discrete time (tₒ−a) and discrete time t₀. The following description is given for: a case that the virtual sound source 101_{—}n moves in a direction of departing from the speaker 103_{—}m (the virtual sound source 101_{—}n is departing from the speaker 103_{—}m); and a case that the virtual sound source 101_{—}n moves in a direction of approaching (the virtual sound source 101_{—}n is approaching the speaker 103_{—}m).

G_{n,t} and τ_{mn,t} also vary in correspondence to the distance that the virtual sound source 101_{—}n moves between discrete time (t₀−a) and discrete time t₀. The following Equations (9) and (10) express the amount of variation in the gain coefficient that varies in accordance with the distance that the virtual sound source 101_{—}n has moved between discrete time (t₀−a) and discrete time t₀ and the amount of variation in the number of samples corresponding to the sound wave propagation time. For example, ΔG_{n,t0} expresses the amount of variation of the gain coefficient at discrete time t₀ relative to the gain coefficient at discrete time (t₀−a), and Δτ_{mn,t0} expresses the amount of variation (also referred to as a “time width”) of the number of samples corresponding to the sound wave propagation time at discrete time t₀ relative to the number of samples corresponding to the sound wave propagation time at discrete time (t₀−a). When the virtual sound source moves from discrete time (t₀−a) to discrete time t₀, these amounts of variation take any one of a positive value and a negative value depending on the direction of movement of the virtual sound source 101_{—}n.

$$\begin{matrix}Δ {G}_{n , {t}_{0}} = w ( \frac{1}{\sqrt{\vert {r}_{n , {t}_{0}} - {r}_{m} \vert}} - \frac{1}{\sqrt{\vert {r}_{n , {t}_{0} - a} - {r}_{m} \vert}} ) & ( 9 ) \\ Δ {τ}_{mn , {t}_{0}} = \vert \frac{R}{c } ( \vert {r}_{n , {t}_{0}} - {r}_{m} \vert - \vert {r}_{n , {t}_{0} - a} - {r}_{m} \vert ) \vert & ( 10 )\end{matrix}$$

When the virtual sound source 101_{—}n is departing or approaching relative to the speaker 103_{—}m, ΔG_{n,t0} and time width Δτ_{mn,t0} arise and hence waveform distortion occurs at discrete time t0. Here, a state that “waveform distortion” has occurred indicates a state that the audio signal waveform does not vary continuously and does vary discontinuously to an extent that the part is perceived as noise by the listener.

For example, when the virtual sound source 101_{—}n moves in a direction of departing from the speaker 103_{—}m so that the sound wave propagation time increases, that is, when the time width Δτ_{mn,t0} is positive, in the beginning part of the segment starting at discrete time t₀, the audio data of the final part of the preceding segment appears again for the time width Δτ_{mn,t0}. In the following description, the preceding segment of the segment starting at discrete time t₀ is referred to as a first segment, and the segment starting at discrete time t₀ is referred to as a second segment. As a result, distortion occurs in the waveform.

On the other hand, when the virtual sound source 101_{—}n moves in a direction of approaching the speaker 103_{—}m so that the sound wave propagation time decreases, that is, when the time width Δτ_{mn,t0} is negative, a loss of time width Δτ_{mn,t0} is generated between the audio data of the final part of the first segment and the audio data of the beginning part of the second segment. As a result, a discontinuity point arises in the audio signal waveform. This is also waveform distortion. Detailed examples of distortion in the waveform are described below with reference to the drawings.

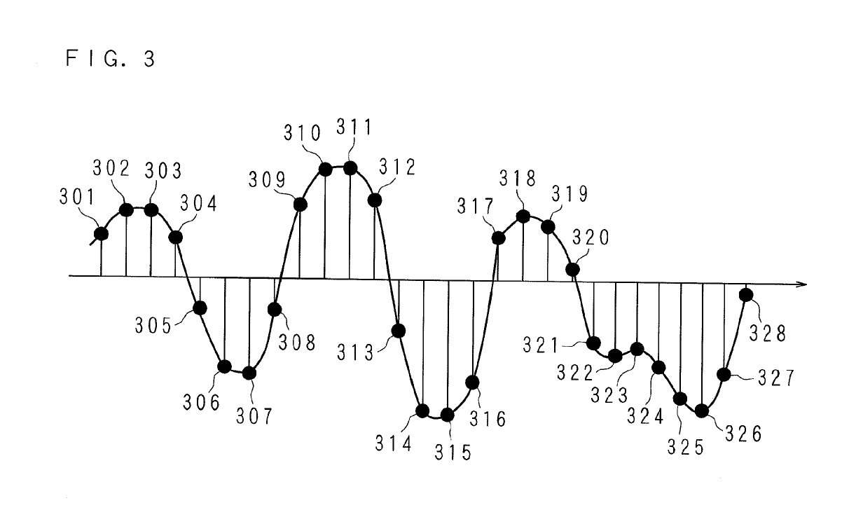

FIG. 3 is an explanation diagram for a part of an audio signal waveform formed on the basis of audio data. It is assumed that the audio data illustrated in FIG. 3 is expressed by a total of 28 pieces of sample data consisting of the sample data 301 to the sample data 328. With reference to the audio signal illustrated in FIG. 3, the reason why waveform distortion is generated is described below for a case that the virtual sound source 101_{—}n moves in a direction of departing from the speaker 103_{—}m and a case that the virtual sound source 101_{—}n moves in a direction of approaching.

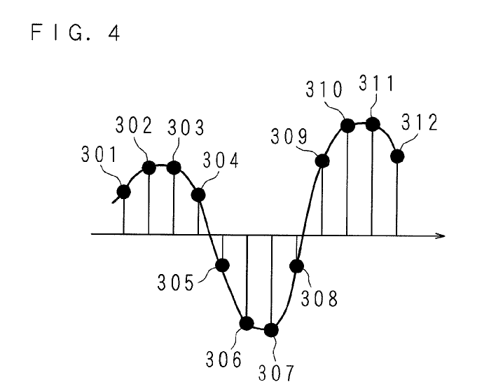

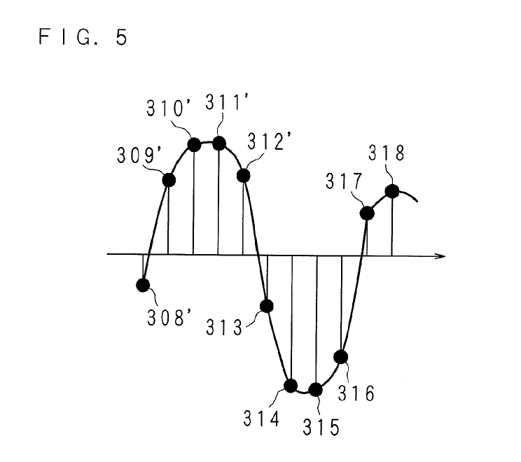

First, description is given for a case that the virtual sound source 101_{—}n moves in a direction of departing from the speaker 103_{—}m so that the sound wave propagation time corresponding to the distance between the position of the virtual sound source 101_{—}n and the position of the speaker 103_{—}m increases, that is, a case that the time width Δτ_{mn,t0} is positive. FIG. 4 is an explanation diagram for an example of an audio signal waveform formed on the basis of audio data within a first segment. The final part of the first segment contains the sample data 301 to 312. FIG. 5 is an explanation diagram for an example of an audio signal waveform formed on the basis of audio data within a second segment. The beginning part of the second segment contains the sample data 308′ to 318.

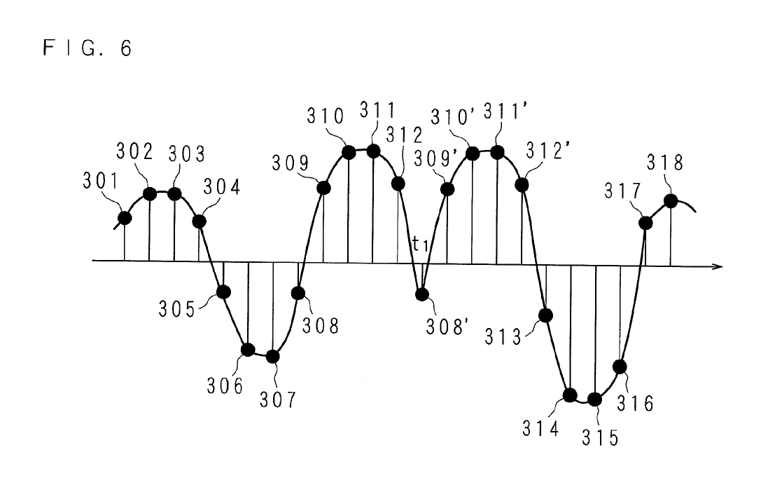

In the present example, it is assumed that the virtual sound source 101_{—}n moves in a direction of departing from the speaker 103_{—}m so that the number of samples corresponding to the sound wave propagation time corresponding to the distance from the virtual sound source 101_{—}n to the speaker 103_{—}m in the second segment increases, for example, by five (=Δτ_{mn,t}) points in comparison with the number of samples corresponding to the sound wave propagation time corresponding to the distance from the virtual sound source 101_{—}n to the speaker 103_{—}m in the first segment. As a result of increase in the sound wave propagation time, the sample data 308, 309, 310, 311, and 312 of the final part of the first segment illustrated in FIG. 4 appear again as the sample data 308′, 309′, 310′, 311′, and 312′ in the beginning part of the second segment illustrated in FIG. 5. Thus, when the audio signal waveform formed on the basis of the audio data illustrated in FIG. 4 and the audio signal waveform formed on the basis of the audio data illustrated in FIG. 5 are combined with each other, waveform distortion occurs in the combined part. FIG. 6 is an explanation diagram for an example of an audio signal waveform obtained by combining an audio signal waveform formed on the basis of the audio data illustrated in FIG. 4 and an audio signal waveform formed on the basis of the audio data illustrated in FIG. 5. As seen from FIG. 6, the audio data becomes discontinuous near the sample data 308′ and distortion occurs in the waveform. This waveform distortion is perceived as noise by the listener.

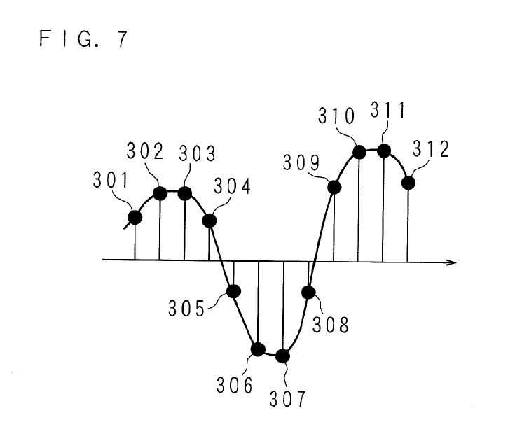

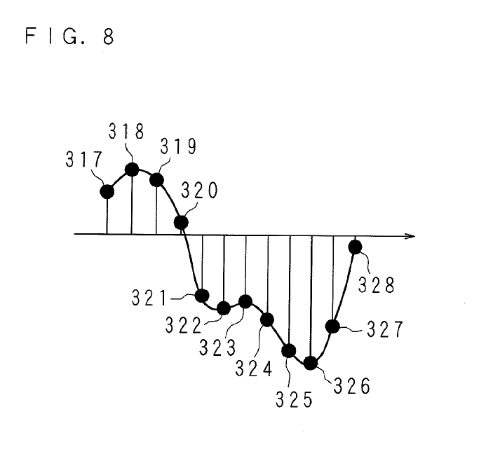

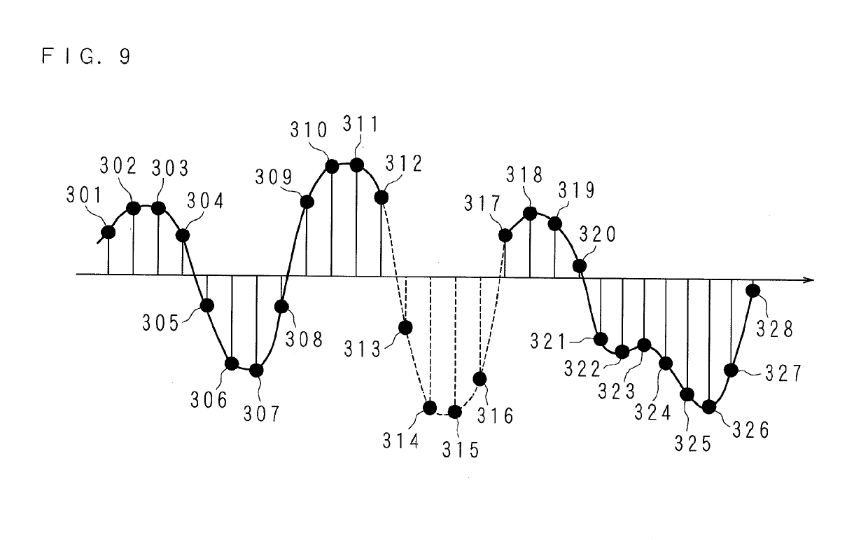

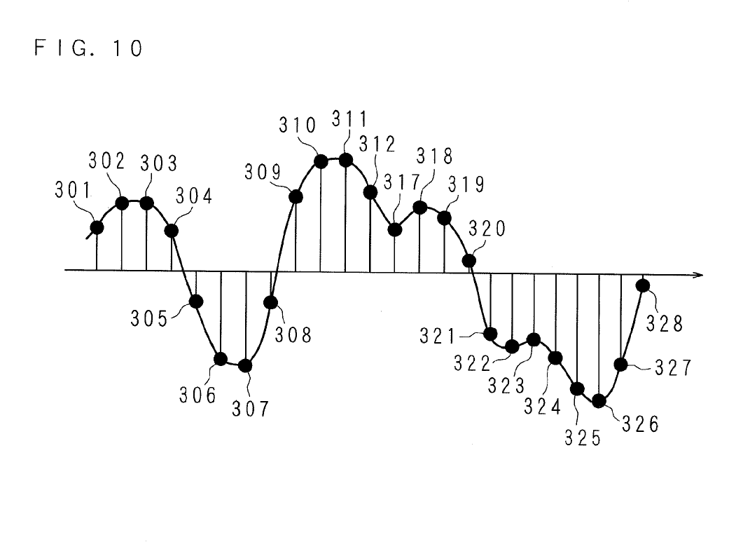

Description is given below for the contrary case that the virtual sound source 101_{—}n moves in a direction of approaching the speaker 103_{—}m so that the sound wave propagation time decreases, that is, a case that the time width Δτ_{mn,t0} is negative. FIG. 7 is an explanation diagram for an example of an audio signal waveform formed on the basis of audio data within a first segment. The final part of the first segment contains the sample data 301 to 312. The contents are the same as those illustrated in FIG. 5. FIG. 8 is an explanation diagram for an example of an audio signal waveform formed on the basis of audio data within a second segment. The beginning part of the second segment contains the sample data 317 to 328. In the present example, it is assumed that the virtual sound source 101_{—}n moves in a direction of approaching the speaker 103_{—}m so that the number of samples corresponding to the sound wave propagation time corresponding to the distance from the virtual sound source 101_{—}n to the speaker 103_{—}m in the second segment decreases, for example, by four (=Δτ_{mn,t}) points in comparison with the number of samples corresponding to the sound wave propagation time corresponding to the distance from the virtual sound source 101_{—}n to the speaker 103_{—}m in the first segment. FIG. 9 is an explanation diagram illustrating a situation that a lost part of four points occurs between an audio signal waveform formed on the basis of audio data of the beginning part of a first segment and an audio signal waveform formed on the basis of audio data of the final part of a second segment. As a result of decrease in the sound wave propagation time, as illustrated in FIG. 9, a lost part of four points (the sample data 313-316) occurs between the audio signal waveform formed on the basis of the audio data of the final part of the first segment and the audio signal waveform formed on the basis of the audio data of the beginning part of the second segment. Thus, when the audio signal waveform formed on the basis of the audio data illustrated in FIG. 7 and the audio signal waveform formed on the basis of the audio data illustrated in FIG. 8 are combined with each other, waveform distortion occurs in the combined part. FIG. 10 is an explanation diagram for an example of an audio signal waveform obtained by combining an audio signal waveform formed on the basis of the audio data illustrated in FIG. 7 and an audio signal waveform formed on the basis of the audio data illustrated in FIG. 8. As seen from FIG. 10, the audio data becomes discontinuous near the sample data 317 and distortion occurs in the waveform. This waveform distortion is similarly perceived as noise by the listener.

The reason why waveform distortion is generated when the virtual sound source 101_{—}n moves has been described above. Next, an embodiment according to the present invention in which audio data is corrected so that waveform distortion is resolved is described in detail with reference to the drawings.

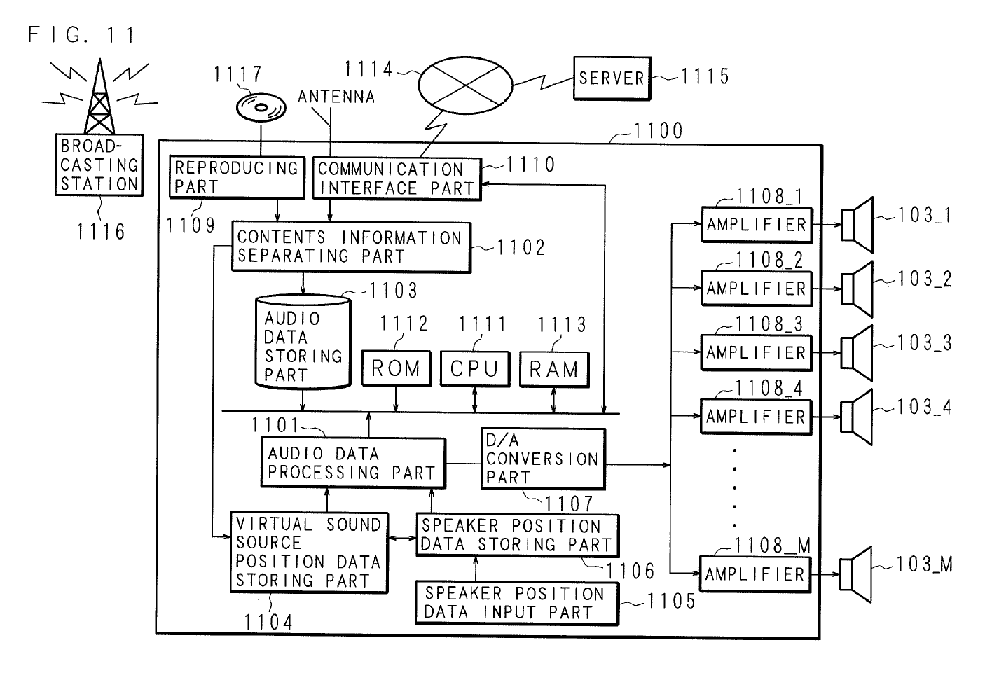

FIG. 11 is a block diagram illustrating an exemplary configuration of an audio apparatus employing an audio data processing part according to Embodiment 1. The audio apparatus 1100 has an audio data processing part 1101 according to Embodiment 1, a contents information separating part 1102, an audio data storing part 1103, a virtual sound source position data storing part 1104, a speaker position data input part 1105, a speaker position data storing part 1106, a D/A conversion part 1107, M pieces of amplifiers 1108_1 to 1108_M, a reproducing part 1109, and a communication interface part 1110. The audio apparatus 1100 further has: a CPU (Central Processing Unit) 1111 comprehensively controlling the above-mentioned parts; a ROM (Read-Only Memory) 1112 storing a computer program executed by the CPU 1111; and a RAM (Random-Access Memory) 1113 storing data, variable, and the like processed during the execution of the computer program. The audio apparatus 1100 outputs to the speaker array 103 an audio signal corresponding to the corrected audio data.

From a recording medium 1117 storing digital contents (such as movies, computer games, and music videos), the reproducing part 1109 reads appropriate digital contents and then outputs the contents to the contents information separating part 1102. The recording medium 1117 is composed of a CD-R (Compact Disc Recordable), a DVD (Digital Versatile Disk), a Blu-ray Disk (registered trademark), or the like. In the digital contents, a plurality of audio data files respectively corresponding to the virtual sound sources 101_1 to 101_N and virtual sound source position data corresponding to the virtual sound sources 101_1 to 101_N are recorded in a manner of correspondence to each other.

The communication interface part 1110 acquires digital contents from a server 1115 distributing digital contents via a communication network such as the Internet 1114, and then outputs the acquired contents to the contents information separating part 1102. Further, the communication interface part 1110 is provided with devices (not illustrated) such as an antenna and a tuner, and receives a program broadcasted from a broadcasting station 1116 and then outputs the received program as digital contents to the contents information separating part 1102.

The contents information separating part 1102 acquires digital contents from the reproducing part 1109 or the communication interface part 1110, and then analyzes the digital contents so as to separate audio data and virtual sound source position data from the digital contents. Then, the contents information separating part 1102 outputs the audio data and the virtual sound source position data obtained by the separation, respectively to the audio data storing part 1103 and the virtual sound source position data storing part 1104. For example, when the digital contents is a music video, the virtual sound source position data is position data corresponding to the relative positions of a singer and a plurality of musical instruments displayed on the video screen. The virtual sound source position data is, together with the audio data, stored in the digital contents.

The audio data storing part 1103 stores the audio data acquired from the contents information separating part 1102, and the virtual sound source position data storing part 1104 stores the virtual sound source position data acquired from the contents information separating part 1102. The speaker position data storing part 1106 acquires from the speaker position data input part 1105 the speaker position data specifying the within-the-sound-space positions of the speakers 103_1 to 103_M of the speaker array 103, and then stores the acquired data. The speaker position data is information set up by the user on the basis of the positions of the speakers 103_1 to 103_M constituting the speaker array 103. For example, this information is expressed with reference to coordinates in one plane (X-Y coordinate system) fixed to the audio apparatus within the sound space. The user operates the speaker position data input part 1105 so as to store the speaker position data into the speaker position data storing part 1106. In a case that arrangement of the speaker array 103 is determined in advance from a constraint on the practical mounting, the speaker position data is set up as fixed values. On the other hand, in a case that the user is allowed to determine the arrangement of the speaker array 103 arbitrarily to an extent, the speaker position data is set up as variable values.

The audio data processing part 1101 reads from the audio data storing part 1103 the audio files corresponding to the virtual sound sources 101_1 to 101_N. Further, the audio data processing part 1101 reads from the virtual sound source position data storing part 1104 the virtual sound source position data corresponding to the virtual sound sources 101_1 to 101_N. Further, the audio data processing part 1101 reads from the speaker position data storing part 1106 the speaker position data corresponding to the speakers 103_1 to 103_M of the speaker array 103. On the basis of the virtual sound source position data and the speaker position data having been read, the audio data processing part 1101 performs the processing according to the embodiment onto the read-out audio data. That is, the audio data processing part 1101 performs arithmetic processing on the basis of the above-mentioned calculation model in which the movement of the virtual sound sources 101_1 to 101_N is taken into consideration, so as to generate audio data used for forming audio signals to be provided to the speakers 103_1 to 103_M. The audio data generated by the audio data processing part 1101 is outputted as audio signals through the D/A conversion part 1107, and then outputted through the amplifiers 1108_1 to 1108_M to the speakers 103_1 to 103_M. On the basis of these audio signals, the speakers 103_1 to 103_M generate and emit sound to the sound space.

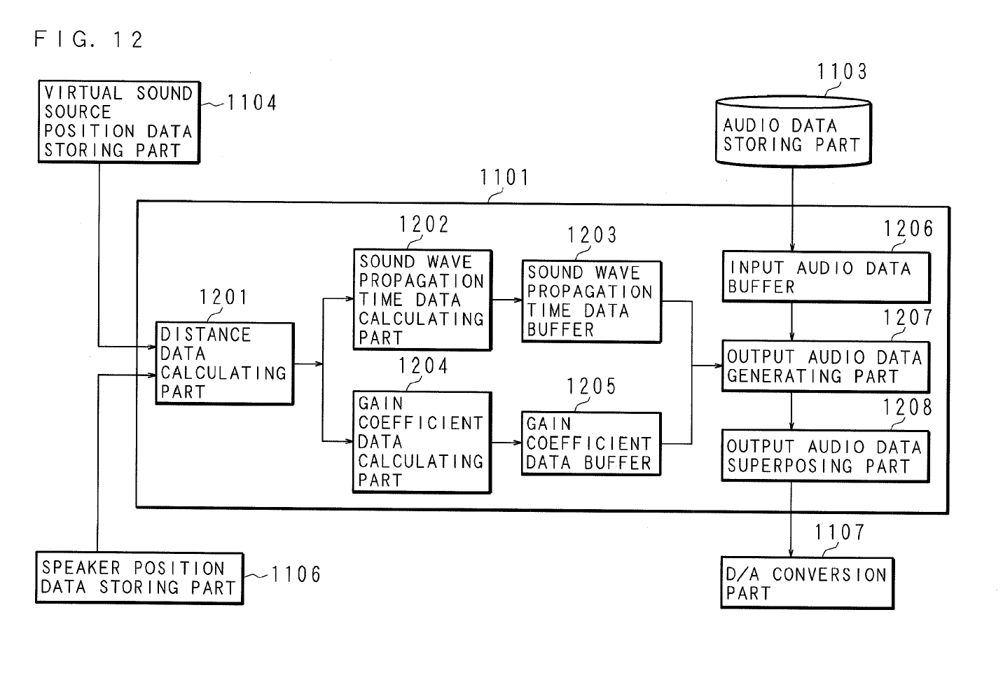

FIG. 12 is a block diagram illustrating an exemplary internal configuration of the audio data processing part 1101 according to Embodiment 1. The audio data processing part 1101 has a distance data calculating part 1201, a sound wave propagation time data calculating part 1202, a sound wave propagation time data buffer 1203, a gain coefficient data calculating part 1204, a gain coefficient data buffer 1205, an input audio data buffer 1206, an output audio data generating part 1207, and an output audio data superposing part 1208. The distance data calculating part 1201 is connected to the virtual sound source position data storing part 1104 and the speaker position data storing part 1106. The input audio data buffer 1206 is connected to the audio data storing part 1103. The output audio data superposing part 1208 is connected to the D/A conversion part 1107.

The distance data calculating part 1201 acquires the virtual sound source position data and the speaker position data respectively from the virtual sound source position data storing part 1104 and the speaker position data storing part 1106, then, on the basis of these data, calculates distance data (|r_{n,t}−rₘ|) between the virtual sound source 101_{—}n and each of the speakers 103_1 to 103_M, and then outputs the calculated data to the sound wave propagation time data calculating part 1202 and the gain coefficient data calculating part 1204. On the basis of the distance data (|r_{n,t}−τₘ|) acquired from the distance data calculating part 1201, the sound wave propagation time data calculating part 1202 calculates sound wave propagation time data (the number of samples corresponding to the sound wave propagation time) τ_{mn,t} (see Equation (7)). The sound wave propagation time data buffer 1203 acquires the sound wave propagation time data τ_{mn,t} from the sound wave propagation time data calculating part 1202, and then temporarily stores the sound wave propagation time data corresponding to plural segments. On the basis of the distance data (|r_{n,t}−rₘ|) acquired from the distance data calculating part 1201, the gain coefficient data calculating part 1204 calculates gain coefficient data G_{n,t} (see Equation (6)).

The input audio data buffer 1206 acquires from the audio data storing part 1103 the input audio data corresponding to the virtual sound sources 101_1 to 101_N, and then stores temporarily the input audio data corresponding to plural segments. For example, one segment is composed of 256 pieces of audio data or 512 pieces of audio data. Using the sound wave propagation time data τ_{mn,t} calculated by the sound wave propagation time data calculating part 1202 and the gain coefficient data G_{n,t} calculated by the gain coefficient data calculating part 1204, the output audio data generating part 1207 generates output audio data corresponding to the input audio data temporarily stored in the input audio data buffer 1206. The output audio data superposing part 1208 synthesizes audio data for the sound corresponding to the output audio data generated by the output audio data generating part 1207, in accordance with the number of virtual sound sources 101.

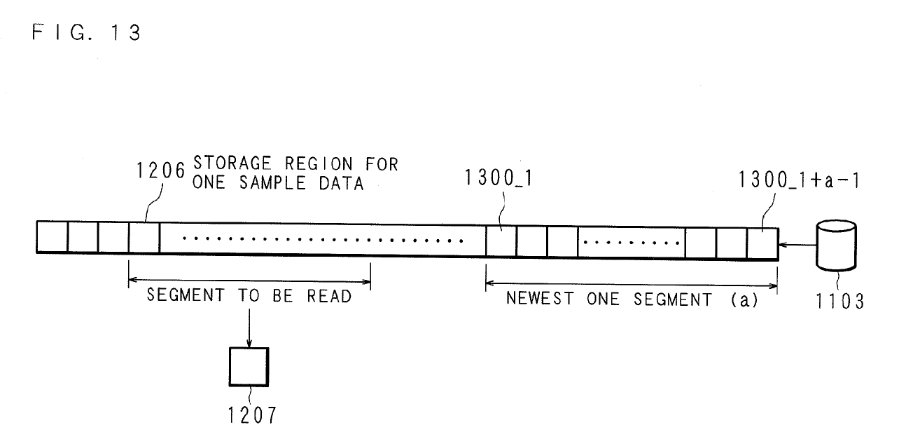

FIG. 13 is an explanation diagram for an exemplary configuration of the input audio data buffer 1206. The input audio data buffer 1206 temporarily stores the data by the FIFO (First-In First-Out) method, and hence discards older data. In general, it is sufficient that its buffer size is set up on the basis of the width corresponding to the number of samples of the maximum value of the distance between the virtual sound source and the speaker. For example, when the maximum value is assumed to be 34 meters, in a case that the sampling frequency is 44100 hertz and the speed of sound is 340 meters/second, it is sufficient that the prepared size is 44100×34/340=4410 samples or greater. The input audio data buffer 1206 reads the input audio data from the audio data storing part 1103 in accordance with the buffer size, then stores the data, and then outputs the data to the output audio data generating part 1207. That is, the output to the output audio data generating part 1207 is not necessarily by a sequential method that the order data is outputted earlier. Each square block in FIG. 13 represents a sample data storage region. Then, one sample data piece within a segment is temporarily stored into the sample data storage region. According to FIG. 13, for example, one sample data piece of the beginning part of the newest segment is temporarily stored in the sample data storage region 1300_1, and one sample data piece of the final part of the newest segment, that is, the newest one sample data piece is temporarily stored in the sample data storage region 1300_1+a−1. Here, “a” denotes the segment length which is the number of sample data pieces contained in one segment.

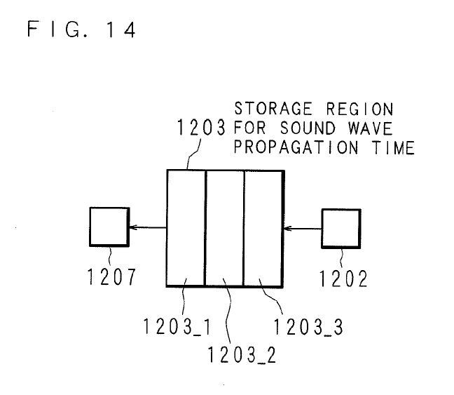

FIG. 14 is an explanation diagram for an exemplary configuration of the sound wave propagation time data buffer 1203. The sound wave propagation time data buffer 1203 also is a temporary storage part for inputting and outputting data by the FIFO (First-In First-Out) method. Each square block in FIG. 14 represents a data storage region. Then, the sound wave propagation time data of each segment is temporarily stored into the data storage region. Further, FIG. 14 illustrates a situation that the sound wave propagation time data for three segments are temporarily stored in the sound wave propagation time data buffer 1203. Further, FIG. 14 illustrates a situation that the oldest the sound wave propagation time data is temporarily stored in the data storage region 1203_1 of the sound wave propagation time data buffer 1203 and that the newest sound wave propagation time data is temporarily stored in the data storage region 1203_3. Further, although not illustrated, the gain coefficient data buffer 1205 has the same configuration as the sound wave propagation time data buffer 1203.

Main operation in an embodiment is described below with reference to FIGS. 12 to 14. The input audio data buffer 1206 reads from the audio data storing part 1103 the input audio data of one segment extending from discrete time t₁ to discrete time (t₁+a−1), and then temporarily stores the read-out data. The following description is given with reference to FIG. 13. Sample data from discrete time t₁ to discrete time (t₁+a+1) are stored in order into the sample data storage region 1300_1 to the sample data storage region (1300_1+a−1). Further, input audio data of plural segments prior to discrete time t₁ are already stored in the data storage regions other than the sample data storage regions 1300_1 to 1300_1+a−1.

The distance data calculating part 1201 calculates the distance data (|r_{1,t1}−τ₁|) expressing the distance at discrete time t₁ between the first virtual sound source (referred to as the “virtual sound source 101_1”, hereinafter) and the first speaker (referred to as the “speaker 103_1”, hereinafter), and then outputs the calculated data to the sound wave propagation time data calculating part 1202 and the gain coefficient data calculating part 1204.

Using Equation (7), on the basis of the distance data (|r_{1,t1}−r₁|) acquired from the distance data calculating part 1201, the sound wave propagation time data calculating part 1202 calculates the sound wave propagation time data τ_{11,t1} and then outputs the calculated data to the sound wave propagation time data buffer 1203.

The sound wave propagation time data buffer 1203 stores the sound wave propagation time data τ_{11,t1} acquired from the sound wave propagation time data calculating part 1202. With reference to FIG. 14, the data having been stored in the data storage region 1203_2 is moved to 1203_1 and the data having been stored in 1203_3 is moved to 1203_2. Then, the sound wave propagation time data τ_{11,t1} is stored into the data storage region 1203_3. Here, the sound wave propagation time data buffers are prepared in a number equal to (the number of speakers)×(the number of virtual sound sources present at time t₁). That is, at least M×N the sound wave propagation time data buffers are prepared and each buffer stores the sound wave propagation time data of the past two segments and the present sound wave propagation time data.

Using Equation (6), on the basis of the distance data (|r_{1,t1}−r₁|) acquired from the distance data calculating part 1201, the gain coefficient data calculating part 1204 calculates gain coefficient data G_{1,t1} and then outputs the obtained result to the gain coefficient data buffer 1205. The gain coefficient data buffer 1205 stores the gain coefficient data G_{1,t1} in a form similar to the sound wave propagation time data buffer 1203. Here, the gain coefficient data buffers are prepared in a number equal to (the number of speakers)×(the number of virtual sound sources present at time t₁). That is, at least M×N the gain coefficient data buffers are prepared and each buffer stores the gain coefficient data of the past two segments and the present gain coefficient data.

When the above-mentioned processing is repeated by a number of times equal to the number (M pieces) of speakers, the sound wave propagation time data τ_{mn,t1} of the speakers 103_1 to 103_M are stored into the sound wave propagation time data buffer 1203 and the gain coefficient data G_{n,t1} of the speakers 103_1 to 103_M are stored into the gain coefficient data buffer 1205.

Then, the input audio data buffer 1206 reads from the audio data storing part 1103 the input audio data within the next segment, that is, within one segment extending from discrete time (t₁+a) to discrete time (t₁+2a−1), and then temporarily stores the read-out data. Then, the sound wave propagation time data calculating part 1202 and the gain coefficient data calculating part 1204 performs the same processing as the above-mentioned one so as to calculate the sound wave propagation time data τ_{mn,(t1+a)} of the speakers 103_1 to 103_M and the gain coefficient data G_{n,t1+a} and then temporarily store the obtained data respectively into the sound wave propagation time data buffer 1203 and the gain coefficient data buffer 1205. At that time, the sound wave propagation time data buffer 1203 stores the sound wave propagation time data τ_{mn,(t1-a)}, τ_{mn,t1}, and τ_{mn,(t1+a)} corresponding to three segments respectively starting at discrete time points (t₁−a), t₁, and (t₁+a). Further, the gain coefficient data buffer 1205 stores the gain coefficient data G_{n,(t1-a), G}_{n,t1}, and G_{n,(t1+a)} corresponding to three segments respectively starting at discrete time (t₁−a), t₁, and (t₁+a).

For the purpose of use in the virtual sound source 101_{—}1, the output audio data generating part 1207 generates the output audio data used for forming audio signals to be provided to the speakers 103_1 to 103_M. In order to generate output audio data at discrete time t₁, the output audio data generating part 1207 reads from the input audio data buffer 1206 the audio data from discrete time (t₁−τ_{mn,t1}) to discrete time (t₁−τ_{mn,t1}+a−1), and then multiplies each data piece by G_{n,t1}.

Here, it is assumed that between discrete time t₁ and discrete time (t₁+a), the virtual sound source 101_{—}n moves in a direction of departing from the speaker 103_{—}m. In this case, the sound wave propagation time data τ_{mn,(t1+n)} becomes greater than the sound wave propagation time data τ_{mn,t1}. Thus, since Δτ_{mn,(t1+a)}=τ_{mn,(t1+a)}−τ_{mn,t1} holds, the time width Δτ_{mn,(t1+a)} becomes positive. In this case, in the beginning part of the segment starting at discrete time (t₁+a), the audio data of the final part of the preceding segment, that is, the segment starting at discrete time t₁, is repeated for the time width Δτ_{mn,(t1+a)}. Here, it is assumed that also between discrete time (t₁−a) and discrete time t₁, the virtual sound source 101_{—}n moves in a direction of departing from the speaker 103_{—}m. Also in this case, the sound wave propagation time data τ_{mn,t} similarly becomes greater than the sound wave propagation time data τ_{mn,(t1-a)}. Thus, since Δτ_{mn,t1}=τ_{mn,t1}−τ_{mn,(t1-a)} holds, the time width Δτ_{mn,t1} becomes positive. Accordingly, in the audio data of the beginning part of the segment starting at discrete time t₁, the audio data of the final part of the preceding segment, that is, the segment starting at discrete time (t₁−a), is repeated for the time width Δτ_{mn,t1}. As a result, in the segment starting at discrete time t₁, waveform distortion occurs relative to each of the preceding and the following segments, that is, the segment starting at discrete time (t₁−a) and the segment starting at discrete time (t₁+a). At this time point, that is, at discrete time t₁, the to-be-corrected segment is the segment starting at discrete time t₁. Then, the to-be-corrected intervals within the segment are two intervals consisting of the part of time width Δτ_{mn,t1} sample that contains waveform distortion between this segment and the preceding segment and the part of time width Δτ_{mn,(t1+a)} sample that contains waveform distortion between this segment and the following segment. At that time, obviously, to-be-corrected intervals consisting of the part of time width Δτ_{mn,t1} sample and the part of time width Δτ_{mn,(t1+a)} sample are contained symmetrically also in the preceding and the following segments of the to-be-corrected segment. Then, in the preceding segment, the interval is already corrected in the correction processing performed for the time point of discrete time (t₁−a). Further, in the following segment, the interval is corrected in the future in the correction processing performed for the time point of discrete time (t₁+a). Here, the contents of processing are the same for the two correction intervals in the to-be-corrected segment. Thus, the following description performed with reference to the drawings is given only for the correction interval part of the distorted waveform generated relative to the following segment, that is, the segment that follows the to-be-corrected segment.

With reference to FIG. 6 again, before the correction of audio data, the correction interval within the to-be-corrected segment, that is, the audio data from discrete time (t₁+a−Δτ_{mn,(t1+a)}) to discrete time (t₁+a−1) is the audio data obtained by joining the sample data 308, 309, 310, 311, and 312 within the segment starting at discrete time t₁. This audio data appears again as the audio data obtained by joining the sample data 308, 309, 310, 311, and 312 from discrete time (t₁+a) to discrete time (t₁+a+Δτ_{mn,(t1+a)}−1) in the segment starting at discrete time (t₁+a), that is, in the following segment of the to-be-corrected segment. As a result, as described above, in the segment starting at discrete time t₁, waveform distortion occurs relative to the segment starting at discrete time (t₁+a). Thus, correction processing is performed on the audio data so that the audio signal waveform is expanded and the waveform distortion is resolved.

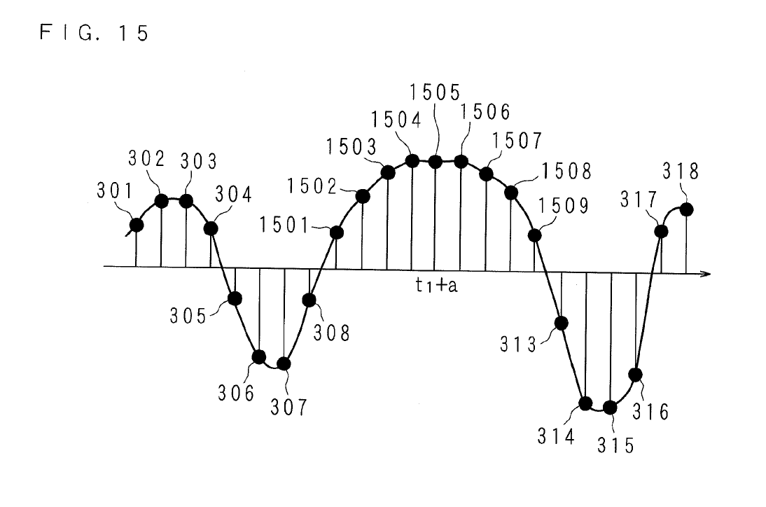

FIG. 15 is an explanation diagram for an audio signal waveform formed on the basis of corrected audio data. First, as the value of the discrete time of the sample data 309, the average of the sample data 308′ and the sample data 309′ is adopted (1501). Then, the sample data 309′ is adopted as the sample data 310 (1502). Further, the average of the sample data 309′ and the sample data 310′ is adopted as the sample data 311 (1503). Further, the sample data 310′ is adopted as the sample data 312 (1504). Here, in the segment following the to-be-corrected segment, the correction processing is not performed at this time. However, for simplicity of description, correction processing to be performed later on this segment is described here. That is, in addition to the above-mentioned processing, the average of the sample data 310′ and the sample data 311′ is adopted as the sample data 308′ (1505). Then, the sample data 311′ is adopted as the sample data 309′ (1506). Further, the average of the sample data 311′ and the sample data 312′ is adopted as the sample data 310′ (1507). Further, the sample data 312′ is adopted as the sample data 311′ (1508). Further, the average of the sample data 312′ and the sample data 313 is adopted as the sample data 312′ (1509). In conclusion, the above-mentioned processing is such that in the entire interval where the waveform of time width Δτ_{mn,(t1+a)} is repeated twice, the not-yet-repeated waveform is uniformly expanded into twice the time width, that is, the sample value is adopted at every 0.5. Here, when a sample value corresponding to specified time is not present like a sample value at time 1.5, the average of the sample values at the preceding and the following time points is adopted as described above. Further, in this example, it has been assumed that time widths of the correction intervals each present in each of the to-be-corrected segment and the following segment of this are equal to the time width of one component waveform of the twice-repeated waveform. However, each time width may have a length proportional to its time width. As such, processing of replacement of the sample data is performed so that the audio data is corrected relative to the segment starting at discrete time tᵢ and the segment starting at discrete time (t₁+a).

As a result, as seen from FIG. 15, repetition of the audio signal waveform disappears near discrete time (t₁+a) and hence the waveform distortion having been generated is resolved. Thus, the audio signal waveform becomes of a smooth curve. Similarly, also as for the waveform distortion relative to the segment starting at discrete time t₁ and the segment starting at discrete time (t₁−a), time width Δτ_{mn,t1} calculated from τ_{mn,(t1-a)} and τ_{mn,t1} stored in the sound wave propagation time data buffer 1203 is used and then the above-mentioned correction processing for the audio data is performed. As a result, in the segment starting at discrete time t₁, waveform distortion having been generated relative to the preceding and the following segments of this is resolved.

Next, on the contrary to the above-mentioned example, it is assumed that the virtual sound source 101_{—}n has moved in a direction of approaching the speaker 103_{—}m between discrete time t₁ and discrete time (t₁+a). In this case, the sound wave propagation time data τ_{mn,(t1+a)} becomes smaller than the sound wave propagation time data τ_{mn,t1}. Thus, since Δτ_{mn,(t1+a)}=τ_{mn,(t1+a)}−τ_{mn,t1} holds, the time width Δτ_{mn,(t1+a)} becomes negative. In this case, the audio data is lost relative to the segment starting at discrete time t₁ and the segment starting at discrete time (t₁+a). Further, it is assumed that the virtual sound source 101_{—}n has moved in a direction of approaching the speaker 103_{—}m also between discrete time (t₁−a) and discrete time t₁. Also in this case, the sound wave propagation time data τ_{mn,t1} becomes smaller than the sound wave propagation time data τ_{mn,(t1-a)}. Thus, since Δτ_{mn,t1}=τ_{mn,t1}−τ_{mn,(t1-a)} holds, the time width Δτ_{mn,t1} becomes negative. In this case, the audio data is lost relative to the segment starting at discrete time (t₁−a) and the segment starting at discrete time t₁.

In the above-mentioned case, in the segment starting at discrete time t₁, waveform distortion occurs relative to each of the preceding and the following segments, that is, the segment starting at discrete time (t₁−a) and the segment starting at discrete time (t₁+a). At this time, that is, at discrete time t₁, similarly to the above-mentioned example, the to-be-corrected segment is the segment starting at discrete time t₁. Then, the to-be-corrected intervals within the segment are two intervals consisting of the part of time width Δτ_{mn,t1} sample that contains waveform distortion between this segment and the preceding segment and the part of time width Δτ_{mn,(t1+a)} sample that contains waveform distortion between this segment and the following segment. At that time, obviously, to-be-corrected intervals consisting of the part of time width Δτ_{mn,t1} sample and the part of time width Δτ_{mn,(t1+a)} sample are contained symmetrically also in the preceding and the following segments of the to-be-corrected segment. Then, in the preceding segment, the interval is already corrected in the correction processing performed for the time point of discrete time (t₁−a). Further, in the following segment, the interval is corrected in the future in the correction processing performed for the time point of discrete time (t₁+a). Here, the contents of processing are the same for the two correction intervals in the to-be-corrected segment. Thus, the following description performed with reference to the drawings is given only for the correction interval part of the distorted waveform generated relative to the following segment, that is, the segment that follows the to-be-corrected segment.

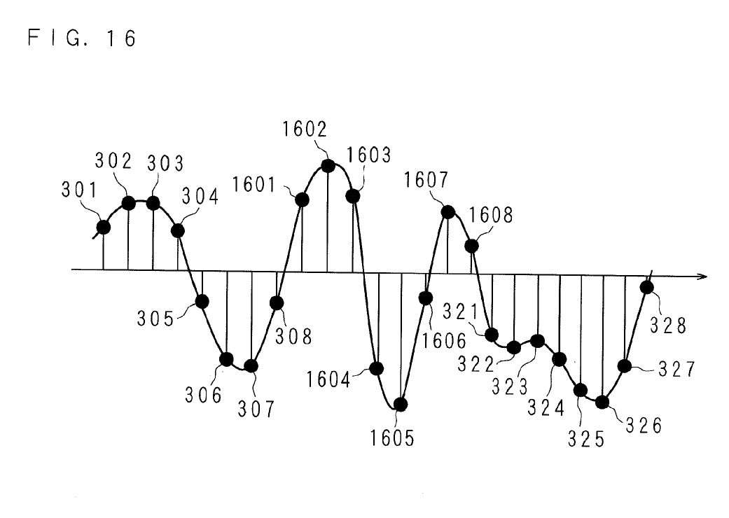

With reference to FIG. 10 again, before the correction of audio data, the to-be-corrected interval, that is, the audio data from discrete time (t₁+a−Δτ_{mn,(t1+a)} to discrete time (t₁+a−1) is the audio data obtained by joining the sample data 309, 310, 311, and 312 within the segment starting at discrete time t₁. Further, since four points of the sample data 313 to 316 illustrated in FIG. 9 are lost, the waveform is discontinuous at the sample data 317 serving as the starting point of the next segment. Thus, correction processing is performed on the audio data so that the audio signal waveform is compressed and the waveform distortion is resolved. FIG. 16 is an explanation diagram for an audio signal waveform formed on the basis of corrected audio data. First, as the value of the discrete time of the sample data 309, the sample data 309 is adopted (1601). Then, as the value of the discrete time of the sample data 310, the average of the sample data 310 and 311 is adopted (1602). Further, the sample data 312 is adopted as the sample data 311 (1603). Further, the average of the sample data 313 and the sample data 314 is adopted as the sample data 312 (1604). Here, in the segment following the to-be-corrected segment, the correction processing is not performed at this time. However, for simplicity of description, correction processing to be performed later on this segment is described here. That is, in addition to the above-mentioned processing, the sample data 315 is adopted as the sample data 317 (1605). Further, the average of the sample data 316 and the sample data 317 is adopted as the sample data 318 (1606). Further, the sample data 318 is adopted as the sample data 319 (1607). Further, the average of the sample data 319 and the sample data 320 is adopted as the sample data 320 (1608). In conclusion, the above-mentioned processing is such that in the preceding and the following intervals of time width Δτ_{mn,(t1+a)} of the interval where the waveform of time width Δτ_{mn,(t1+a)} is lost, the waveform of time width (3×Δτ_{mn,(t1+a)}) obtained by adding the waveforms of the lost parts to the waveform of the interval of interest is uniformly compressed into ⅔ of the time width, that is, the sample value is adopted at every 1.5. Here, similarly to the above-mentioned example, when a sample value corresponding to specified time is not present like a sample value at time 1.5, the average of the sample values at the preceding and the following time points is adopted as described above. Further, in this example, it has been assumed that the time widths of the correction intervals present on both sides of the lost part are equal to the time width of the lost part. However, each time width may have a length proportional to its time width. Further, in every example, the time width Δτ_{mn,t1} and the time width Δτ_{mn,(t1+a)} have been assumed to have the same sign. However, these time widths may have different signs from each other, or alternatively may be 0. In these cases, when the value is 0, the correction processing is not performed. When the value is not 0, any one of the correction processing of the above-mentioned examples is performed depending on the sign of the value.

Similar calculation is performed for the next virtual sound source 101_{—}n. Then, the output audio data superposing part 1208 superposes the output audio data for each virtual sound source 101_{—}n so as to synthesize audio data. This processing is repeated by a number of times equal to the number of speakers. In this example, it has been assumed that the correction width for the first part within the segment of the output audio data at discrete time tᵢ is equal to the time width Δτ_{mn,t1}. However, the correction width may be a multiple of the time width Δτ_{mn,t1}. Further, as illustrated in FIG. 16, as long as a smooth audio signal waveform is obtained, replacement of the sample data may be performed by another method.

As described above, audio data is corrected so that waveform distortion is resolved. Then, correction processing based on the gain coefficient data is further performed. As described above, when the virtual sound source 101_{—}n moves, the gain coefficient data also varies. Thus, the gain coefficient is changed gradually along the correction interval width. When the gain coefficient for the to-be-corrected segment is G1 and the gain coefficient for the following segment of the to-be-corrected segment is G2, the gain coefficient for each point within the correction interval of interest becomes G=qG2+(1−q)G1. Here, q is changed from 0 to 0.5 along the correction interval. It should be noted that in the first correction interval within the following segment, at the time of correction processing, this q is changed from 0.5 to 1 along the correction interval. The way of changing may be linear or any function. As a result, the gain coefficient is changed without causing waveform distortion.

The above-mentioned processing is executed repeatedly in accordance with the number of the virtual sound sources 101_{—}n and the number of the speakers 103_{—}m, so that waveform distortion generated when the virtual sound source 101_{—}n moves is resolved. This remarkably reduces the noise caused by the waveform distortion.

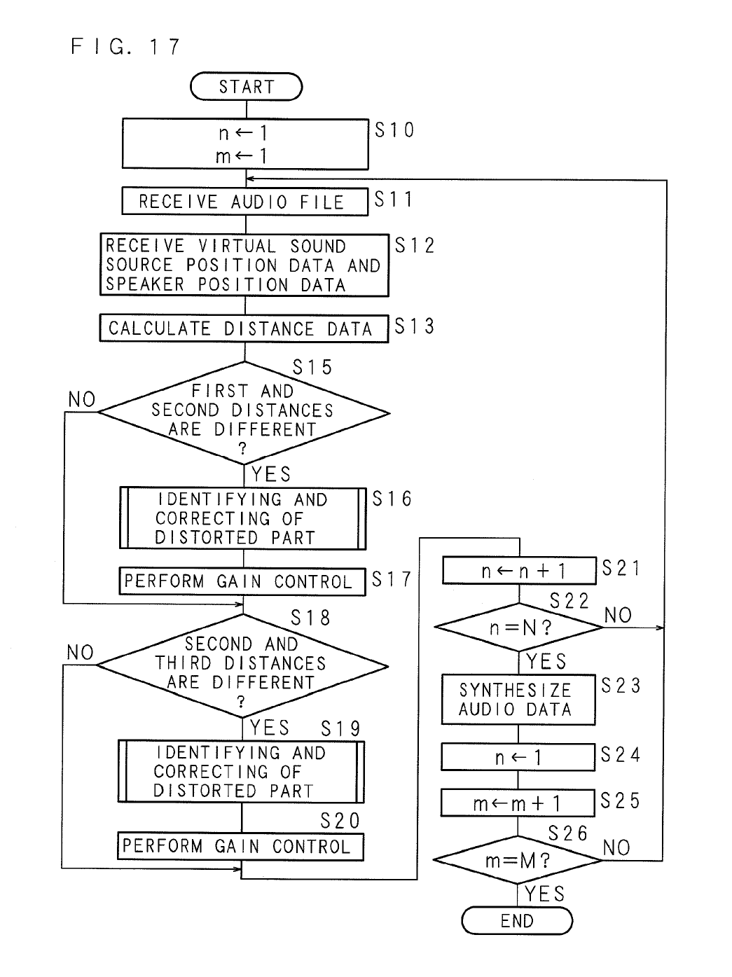

FIG. 17 is a flow chart describing flow of data processing according to Embodiment 1. This data processing is executed by the audio data processing part 1101 under the control of the CPU 1111. First, the audio data processing part 1101 substitutes 1 into the number n of the virtual sound source 101_{—}n and substitutes 1 into the number m of the speaker 103_{—}m. That is, the first virtual sound source 101_1 and the first speaker 103_1 are specified (S10). The audio data processing part 1101 receives from the audio data storing part 1103 the audio file for the n-th virtual sound source 101_{—}n (S11). Further, the audio data processing part 1101 receives the virtual sound source position data corresponding to the virtual sound source 101_{—}n and the speaker position data from the virtual sound source position data storing part 1104 and the speaker position data storing part 1106, respectively (S12). On the basis of the virtual sound source position data and the speaker position data having been received, the audio data processing part 1101 calculates the distance data (|r_{n,t}−rₘ|) between the virtual sound source 101_{—}n and the speaker 103_{—}m (S13). On the basis of the calculated distance data (|r_{n,t}−rₘ|), the audio data processing part 1101 compares the distance data (the first and the second distances, hereinafter) corresponding to each of the second preceding segment and the immediately preceding segment (S15). Similarly, the audio data processing part 1101 compares the distance data (the second and the third distances, hereinafter) corresponding to each of the preceding segment and the newest segment (S18). That is, at step S15, the audio data processing part 1101 judges whether the virtual sound source 101_{—}n has moved or stood still relative to the speaker 103_{—}m between the time point of the second preceding segment and the time point of the immediately preceding segment. Similarly, at step S18, the audio data processing part 1101 judges whether the virtual sound source 101_{—}n has moved or stood still relative to the speaker 103_{—}m between the time point of the preceding segment and the time point of the newest segment.

At step S15, when it is judged that the first and the second distances are different from each other (S15: YES), that is, when it is judged that the virtual sound source 101_{—}n has moved, the audio data processing part 1101 identifies and corrects the part of waveform distortion caused by the relation between the to-be-corrected segment and the preceding segment (S16). In contrast, when it is judged that the first and the second distances are the same (S15: NO), that is, when it is judged that the virtual sound source 101_{—}n has stood still, the audio data processing part 1101 goes to the processing of step S18. Details of step S18 are described later. Then, the audio data processing part 1101 performs gain control (S17). Then, the audio data processing part 1101 compares the second and third distances with each other similarly to step S15 (S18). At step S18, when it is judged that the second and the third distances are different from each other (S18: YES), that is, when it is judged that the virtual sound source 101_{—}n has moved, the audio data processing part 1101 identifies and corrects the part of waveform distortion caused by the relation between the to-be-corrected segment and the following segment (S19) and then performs gain control (S20). In contrast, when it is judged that the second and the third distances are the same (S18: NO), that is, when it is judged that the virtual sound source 101_{—}n has stood still, the audio data processing part 1101 goes to the processing of step S21. Then, the audio data processing part 1101 adds 1 to the number n of the virtual sound source 101_{—}n (S21) and then judges whether the number n of the virtual sound source 101_{—}n is equal to the maximum value N (S22). As a result of the judgment at step S21, when the number n of the virtual sound source 101_{—}n is not equal to the maximum value N (S22: NO), the audio data processing part 1101 returns to the processing of step S11, and then performs the processing of step S11 to step S21 for the second virtual sound source 101_2 and the first speaker 103_1. In contrast, when the number n of the virtual sound source 101_{—}n is equal to the maximum value N (S22: YES), audio data is synthesized (S23). Then, the audio data processing part 1101 substitutes 1 into the number n of the virtual sound source 101_{—}n (S24), and then adds 1 to the number m of the speaker (S25). Then, the audio data processing part 1101 judges whether the number m of the speaker is equal to the maximum value M (S26). When the number m of the speaker is not equal to the maximum value M (S26: NO), the audio data processing part 1101 returns to the processing of S11. When the number m of the speaker is equal to the maximum value M (S26: YES), the audio data processing part 1101 terminates the processing.

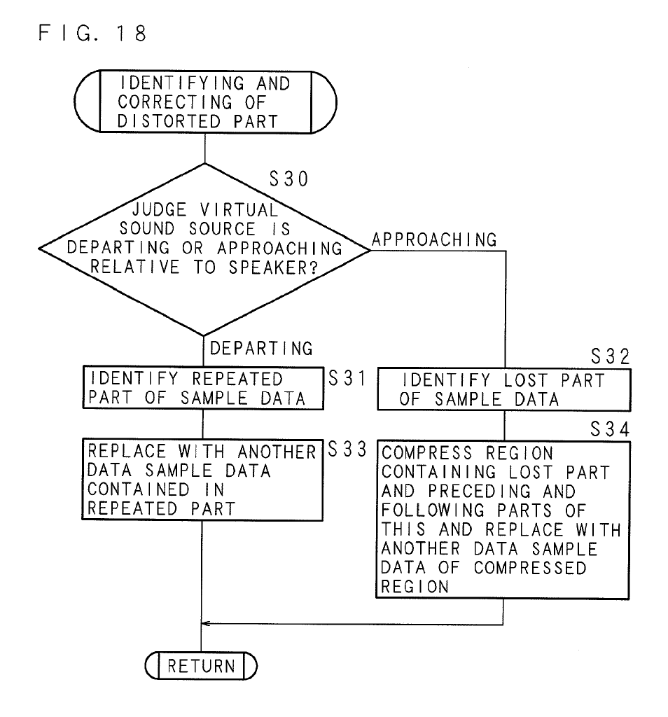

FIG. 18 is a flow chart describing flow of the processing of identifying and correcting the part of waveform distortion (step S16 and step S19 in FIG. 17). In this part, regardless of whether the flow has moved from step S16 or step S19, the processing is performed only within the to-be-corrected segment. When the flow is one having moved from step S16, waveform distortion caused by the relation between the to-be-corrected segment and the preceding segment is corrected. Further, when the flow is one having moved from step S19, waveform distortion caused by the relation between the to-be-corrected segment and the following segment is corrected. The audio data processing part 1101 judges whether the virtual sound source 101_{—}n is departing or approaching relative to the speaker 103_{—}m (S30). When the sound wave propagation time of the latter segment is greater than the sound wave propagation time of the former segment, the audio data processing part 1101 judges that the virtual sound source 101_{—}n is departing from the speaker 103_{—}m (S30: DEPARTING), and then goes to the processing of step S31. In contrast, when the sound wave propagation time of the latter segment is smaller than the sound wave propagation time of the former segment, the audio data processing part 1101 judges that the virtual sound source 101_{—}n is approaching the speaker 103_{—}m (S30: APPROACHING), and then goes to the processing of step S32 so as to identify a lost part of the sample data (S32). The audio data processing part 1101 identifies a repeated part of the sample data (S31). That is, as described above, this repeated part appears in the final part of the former segment or the beginning part of the latter segment.

The audio data processing part 1101 replaces with another data the sample data contained in the repeated part (S33). With reference to FIG. 6, when the flow is one having moved from step S16, that is, when the to-be-corrected segment is the latter segment, the average of the sample data 310′ and the sample data 311′ is adopted as the sample data 308′ (1505). Then, the sample data 311′ is adopted as the sample data 309′ (1506). Further, the average of the sample data 311′ and the sample data 312′ is adopted as the sample data 310′ (1507). Further, the sample data 312′ is adopted as the sample data 311′ (1508). Further, the average of the sample data 312′ and the sample data 313 is adopted as the sample data 312′ (1509). On the contrary, when the to-be-corrected segment is the former segment, as the value of the discrete time of the sample data 309, the average of the sample data 308′ and the sample data 309′ is adopted (1501). Then, the sample data 309′ is adopted as the sample data 310 (1502). Further, the average of the sample data 309′ and the sample data 310′ is adopted as the sample data 311 (1503). Further, the sample data 310′ is adopted as the sample data 312 (1504). In conclusion, in general, in the entire interval where the waveform of time width Δτ_{mn,(t1+a)} is repeated twice, the not-yet-repeated waveform is uniformly expanded into twice the time width, that is, the sample value is adopted at every 0.5. Here, when a sample value corresponding to specified time is not present like a sample value at time 1.5, the average of the sample values at the preceding and the following time points is adopted as described above.

On the other hand, the audio data processing part 1101 compresses the region containing the lost part and the preceding and the following parts of this, then replaces with another data the sample data of the compressed region (S34). For example, with reference to FIGS. 9 and 16, the waveform is discontinuous near the sample data 317. When the flow is one having moved from step S16, that is, when the to-be-corrected segment is the latter segment, the sample data 315 is adopted as the sample data 317 (1605). Then, the average of the sample data 316 and 317 is adopted as the sample data 318 (1606). Further, the sample data 318 is adopted as the sample data 319 (1607). Then, the average of the sample data 319 and 320 is adopted as the sample data 320 (1608). On the contrary, when the flow is one having moved from step S19, that is, when the to-be-corrected segment is the former segment, the average of the sample data 310 and 311 is adopted as the sample data 310 (1602). Further, the sample data 312 is adopted as the sample data 311 (1603). Further, the average of the sample data 313 and the sample data 314 is adopted as the sample data 312 (1604). In conclusion, in general, the above-mentioned processing is such that in the preceding and the following intervals of time width Δτ_{mn,(t1+a)} of the interval where the waveform of time width Δτ_{mn,(t1+a)} is lost, the waveform of time width 3×Δτ_{mn,(t1+a)} obtained by adding the waveforms of the lost parts to the waveform of the interval of interest is uniformly compressed into ⅔ of the time width, that is, the sample value is adopted at every 1.5. Here, similarly to the above-mentioned example, when a sample value corresponding to specified time is not present like a sample value at time 1.5, as described above, the average of the preceding and following sample values is adopted.

The above-mentioned processing is executed in accordance with the number of the virtual sound sources 101 and the number of the speakers 103, so that waveform distortion generated when the virtual sound source 101 moves is resolved. This remarkably reduces the noise caused by the waveform distortion.

### Embodiment 2

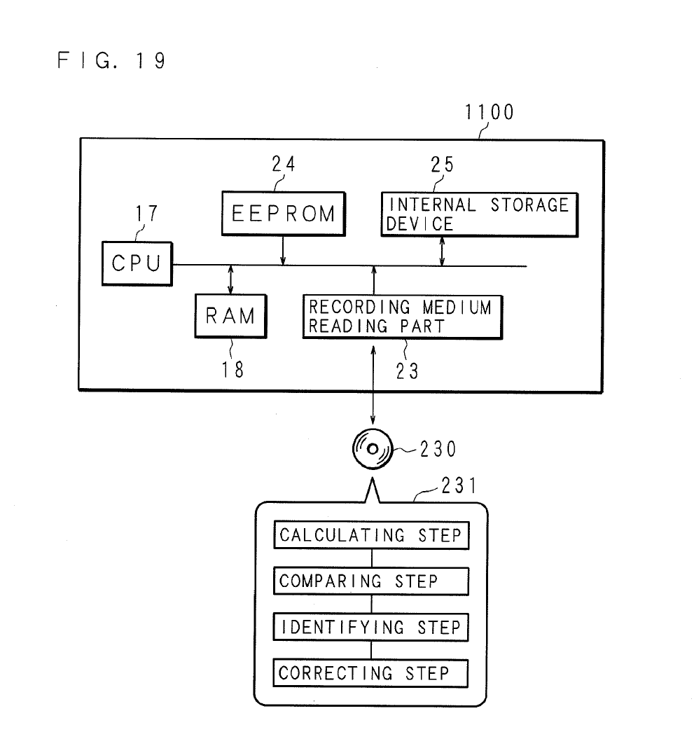

FIG. 19 is a block diagram illustrating an exemplary internal configuration of an audio apparatus according to Embodiment 2. In comparison with Embodiment 1 in which a program stored in the ROM 1112 in the audio apparatus 1100 is executed, in Embodiment 2, a program stored in a rewritable EEPROM (Electrically Erasable Programmable Read-Only Memory) or an internal storage device 25 is read and executed. The audio apparatus 1100 has an EEPROM 24, the internal storage device 25, and a recording medium reading part 23. A CPU 17 reads a program 231 from a recording medium 230 such as a CD(Compact Disk)-ROM and a DVD(Digital Versatile Disk)-ROM inserted into the recording medium reading part 23, and then stores the program into the EEPROM 24 or the internal storage device 25. The CPU 17 loads onto a RAM 18 the program 231 stored in the EEPROM 24 or the internal storage device 25, and then executes the program.

The program 231 is not limited to one read from the recording medium 230 and then stored into the EEPROM 24 or the internal storage device 25. That is, the program 231 may be stored in an external memory such as a memory card. In this case, the program 231 is read from an external memory (not illustrated) connected to the CPU 17, and then stored into the EEPROM 24 or the internal storage device 25. Alternatively, communication may be established between a communication part (not illustrated) connected to the CPU 17 and an external computer, and then the program 231 may be downloaded onto the EEPROM 24 or the internal storage device 25.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-14. (canceled)

15. An audio data processing apparatus that receives audio data corresponding to sound generated by a moving virtual sound source, a position of the virtual sound source, and a position of a speaker emitting sound on the basis of the audio data and that corrects the audio data on the basis of the position of the virtual sound source and the position of the speaker, the apparatus comprising:
a calculating section calculating first and second distances measured at two time points from the position of the speaker to the position of the virtual sound source;
a comparing section comparing the first and the second distances with each other;
an identifying section, when the first and the second distances are different from each other as a result of comparison, identifying a distorted part in the audio data at the two time points; and
a correcting section performing different correction on the audio data of the identified part depending on approaching or departing of the virtual sound source relative to the speaker.

16. The audio data processing apparatus according to claim 15, wherein
the audio data contains sample data,
the identifying section identifies a repeated part of the sample data caused by departing of the virtual sound source from the speaker, and
the correcting section includes a first correcting unit correcting the identified repeated part.

17. The audio data processing apparatus according to claim 16, wherein the part to be processed by the correction has a time width equal to a difference between time widths during propagation of the sound waves through the first and the second distances or a time width proportional to the difference.

18. The audio data processing apparatus according to claim 16, wherein the first correcting section replaces the sample data contained in the identified repeated part with sample data obtained by uniformly expanding, into twice the time width, one of two waveforms formed on the basis of the sample data.

19. The audio data processing apparatus according to claim 15, wherein
the audio data contains sample data,
the identifying section identifies a lost part of the sample data caused by approaching of the virtual sound source to the speaker, and
the correcting section includes a second correcting unit correcting the preceding and the following parts of the identified lost part.

20. The audio data processing apparatus according to claim 19, wherein the part to be processed by the correction has a time width equal to a difference between time widths during propagation of the sound waves through the first and the second distances or a time width proportional to the difference.

21. The audio data processing apparatus according to claim 19, wherein the second correcting section replaces the sample data contained in the identified lost part and in the preceding and the following parts of the lost part with sample data obtained by uniformly compressing into ⅔ of the time width a waveform formed on the basis of the sample data.

22. The audio data processing apparatus according to claim 15, wherein
the audio data contains sample data,
the identifying section identifies a repeated part of the sample data or a lost part of the sample data caused by approaching and departing of the virtual sound source relative to the speaker, and
the correcting section includes:
a first correcting unit correcting the identified repeated part; and
a second correcting unit correcting the preceding and the following parts of the identified lost part.

23. The audio data processing apparatus according to claim 22, wherein the part to be processed by the correction has a time width equal to a difference between time widths during propagation of the sound waves through the first and the second distances or a time width proportional to the difference.

24. The audio data processing apparatus according to claim 22, wherein the first correcting section replaces the sample data contained in the identified repeated part with sample data obtained by uniformly expanding, into twice the time width, one of two waveforms formed on the basis of the sample data.

25. The audio data processing apparatus according to claim 22, wherein the second correcting section replaces the sample data contained in the identified lost part and in the preceding and the following parts of the lost part with sample data obtained by uniformly compressing into ⅔ of the time width a waveform formed on the basis of the sample data.

26. The audio data processing apparatus according to claim 15, further comprising a gain controlling section performing gain control on the audio data corrected by the correcting section.

27. The audio data processing apparatus according to claim 15, wherein the number of the virtual sound sources is unity or a plurality.

28. An audio apparatus that uses audio data corresponding to sound generated by a moving virtual sound source, a position of the virtual sound source, and a position of a speaker emitting sound on the basis of the audio data and that thereby corrects the audio data on the basis of the position of the virtual sound source and the position of the speaker, the apparatus comprising:
a digital contents input part receiving digital contents containing the audio data and the position of the virtual sound source;
a contents information separating part analyzing the digital contents received by the digital contents input part and separating audio data and position data of the virtual sound source contained in the digital contents;
an audio data processing part, on the basis of the position data of the virtual sound source separated by the contents information separating part and position data of the speaker, correcting the audio data separated by the contents information separating part; and
an audio signal generating part, on the basis of the corrected audio data, generating an audio signal to the speaker, wherein
the audio data processing part includes:
a calculating section calculating first and second distances measured at two time points from the position of the speaker to the position of the virtual sound source;
a comparing section comparing the first and the second distances with each other;
a identifying section, when the first and the second distances are different from each other as a result of comparison, identifying a distorted part in the audio data at the two time points; and
a correcting section performing different correction on the audio data of the identified part depending on approaching or departing of the virtual sound source relative to the speaker.

29. The audio apparatus according to claim 28, wherein the digital contents input part receives digital contents from a recording medium storing digital contents, a server distributing digital contents through a network, or a broadcasting station broadcasting digital contents.

30. An audio data processing method employed in an audio data processing apparatus that receives audio data corresponding to sound generated by a moving virtual sound source, a position of the virtual sound source, and a position of a speaker emitting sound on the basis of the audio data and that corrects the audio data on the basis of the position of the virtual sound source and the position of the speaker, the method comprising steps of:
calculating first and second distances measured at two time points from the position of the speaker to the position of the virtual sound source;
comparing the first and the second distances with each other;
identifying a distorted part in the audio data at the two time points, when the first and the second distances are different from each other as a result of comparison; and
performing different correction on the audio data of the identified part depending on approaching or departing of the virtual sound source relative to the speaker.

31. A non-transitory computer-readable medium in which a computer program is recorded causing a computer to receive audio data corresponding to sound generated by a moving virtual sound source, a position of the virtual sound source, and a position of a speaker emitting sound on the basis of the audio data and to correct the audio data on the basis of the position of the virtual sound source and the position of the speaker, the computer program comprising steps of:
causing the computer to calculate first and second distances measured at two time points from the position of the speaker to the position of the virtual sound source;
causing the computer to compare the first and the second distances with each other;
causing the computer to identify a distorted part in the audio data at the two time points, when the first and the second distances are different from each other as a result of comparison; and
causing the computer to perform different correction on the audio data of the identified part depending on approaching or departing of the virtual sound source relative to the speaker.
